(19) United States
(12) Patent Application Publication
(10) Pub. No.: US 2020/0216334 A1
(43) Pub. Date: Jul. 9, 2020

(54) METHOD FOR CONTROLLING pH IN A DIFFUSIOPHORETIC WATER FILTER AND DIFFUSIOPHORETIC WATER FILTER WITH pH CONTROL

(71) Applicant: Split Rock Filter Systems LLC, New Paltz, NY (US)

(72) Inventor: William C. Gehris, New Paltz, NY (US)

(21) Appl. No.: 16/736,549

(22) Filed: Jan. 7, 2020

Related U.S. Application Data
(60) Provisional application No. 62/789,159, filed on Jan. 7, 2019.

(51) Int. Cl. C02F 1/44; C02F 1/66

(52) U.S. Cl. CPC C02F 1/44; C02F 2103/06; C02F 1/66

(57) ABSTRACT

A method of filtering a colloid in a diffusiophoretic water filter including adjusting the pH value of the colloid by adding at least one of an acid or a base upstream of the diffusiophoretic water filter and filtering the colloid in the diffusiophoretic water filter to produce a waste stream and a filtrate is provided.

This claims the benefit of U.S. Provisional Patent Application 62/789,159 filed Jan. 7, 2019 which is hereby incorporated by reference herein.

U.S. patent application Ser. No. 16/262,633, filed on Jan. 30, 2019 and PCT Publication No. WO 2019/099586, filed as PCT/US18/61146 on Nov. 14, 2018 are also hereby incorporated by reference herein.

PCT Publication No. WO 2018/048735 A1 and U.S. Pat. No. 10,155,182 B1 both of which are hereby incorporated by reference herein disclose diffusiophoretic water filters that can remove colloidal particles from water via the process of diffusiophoresis. This process acts on colloidal particles having a surface charge.

### SUMMARY OF THE INVENTION

The diffusiophoretic action of a diffusiophoretic water filter on colloidal particles within the diffusiophoretic water filter and is dependent on the zeta potential of the colloidal particles within the water to be filtered. The zeta potential of many colloidal particles can vary greatly with pH value of the water. Ground water and other sources to be filtered can vary greatly in pH from, for example, 6.0 to 8.5.

The present invention provides a method of adjusting the pH of water to be filtered in a diffusiophoretic water filter comprising:

adjusting the pH value by adding at least one of an acid or a base upstream of the diffusiophoretic water filter.

The present invention provides a method of filtering a colloid in a diffusiophoretic water filter comprising:

adjusting the pH value of the colloid by adding at least one of an acid or a base upstream of the diffusiophoretic water filter; and

filtering the colloid in the diffusiophoretic water filter to produce a waste stream and a filtrate.

The present invention also provides a diffusiophoretic water filtration system comprising: a diffusiophoretic water filter, and an acid or alkali dispenser upstream of the diffusiophoretic water filter.

The present invention also provides a method of operating a diffusiophoretic water filter comprising:

adding a nontoxic acid or alkali to a water to be filtered.

The nontoxic acid can for example be acetic or citric acid, and the nontoxic alkali calcium carbonate or sodium bicarbonate.

The present invention has special use when specific colloidal particles are sought to be filtered, and to improve the diffusiophoretic action on those specific particles.

The present invention thus also provides a method for diffusiophoretically filtering a colloidal particle comprising:

identifying a colloidal particle to be filtered;

identifying or determining a pH of a medium in which the colloidal particle is to be filtered;

identifying or determining a zeta potential of the colloidal particle in the medium; and

filtering the colloidal particle to be filtered as a function of the zeta potential of the particle in the medium.

Thus for example, the input pressure, channel sizes, surface chemistry, gas pressure, flow rate, splitter height or other diffusiophoretic water filter characteristics can be tailored to the identified or determined zeta potential.

The present invention has particular application when seeking to remove chemical contaminants. The colloidal particle thus can be a colloidal particle such as Fe2O3 with an adsorbed chemical contaminant, such as PFOS. The zeta potential of the adhered particulate-contaminant combination should be sufficient so that it can be removed by the diffusiophoretic water filter, and the pH of the colloid greatly influence the zeta potential.

Many contaminants, for example many of the organic chemicals and other contaminants listed on the National Primary Drinking Water Regulations of the Environmental Protection Agency, thus can be removed by the diffusiophoretic water filter of the present invention.

The present invention thus can have a particle disperser that can disperse for example nanoparticles that attract the organic chemicals or other contaminants, for example via adsorption. Preferred nanoparticles include metal oxides in nanoparticulate form, such as Al2O3, Fe2O3, FeOOH, and SiO2, but can include carbon nanotubes or other nanoparticles.

The contaminants may include any PFOAS, PFOS, dioxin, benzene and any chemical or metal ionic species that can be adsorbed or attracted to the particle.

The zeta potential of the adhered particulate-contaminant combination should be sufficient so that it can be removed by the diffusiophoretic water filter, and can be adjusted by the pH and for example temperature of the colloid. Surprisingly, the contaminants actually may improve the diffusiophoretic action of the diffusiophoretic water filter on the nanoparticles in all pH ranges. For example, the electrokinetic potential of aluminum oxide after adsorption of fulvic acid actually stabilizes and this stabilization would be beneficial to the filtration by diffusiophoretic water filter. See Significance of Zeta Potential in the Adsorption of Fulvic Acid on Aluminum Oxide and Activated Carbon, Polish Journal of Environmental Studies 20(6):1381-1386 January 2011.

The present invention thus also provides a method for removing contaminants from water comprising: adding an acid or alkali to the water to alter a zeta potential of at least one contaminant; and imparting diffusiophoretic action on the contaminant to permit the contaminant to be filtered.

### BRIEF DESCRIPTION OF THE DRAWINGS

FIG. 1 shows a schematic of a device according to the present invention.

FIG. 2 shows a method for selecting a nanoparticle for use in a diffusiophoretic water filter to remove a particular contaminant

### DETAILED DESCRIPTION

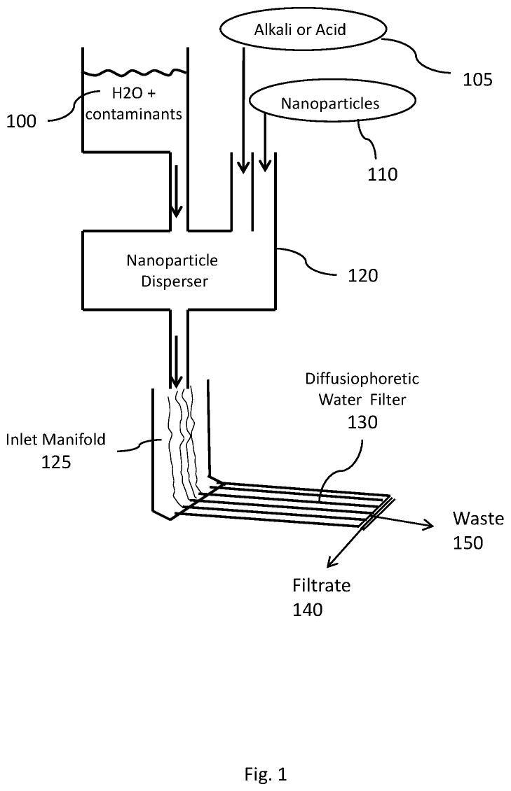

FIG. 1 shows a water source 100 with water and contaminants, for example perfluorooctanic acid (PFOA) or perfluorooctanesulfonic acid (PFOS). A nanoparticle source 110 can provide, for example, synthetic hematite (FE2O3) of a particle size of 10 to 20 nanometers in diameter. The particle can be any type of particle but preferably is a metal oxide nanoparticle that is nontoxic, such as hematite, although if removal via the diffusiophoretic water filter is sufficient, even toxic nanoparticles could be used.

An alkali or acid source 105 is also provided as an input to the particulate disperser 120, either at the disperser or in a holding tank of the disperser 120. For example, acetic acid can be supplied in sufficient quantities to lower the pH of the water from 7.2 to 6.8, without altering the taste, healthfulness or quality of the water significantly.

The particles are provided to a particulate disperser 120 which may be any type of commercial mixing device sufficient to disperse the particles and allow for attraction of the contaminant. This process can take on the order of hours for PFOA and hematite as described for example in the article “Adsorption of perfluorooctanoic acid and perfluorooctanesulfonic acid to iron oxide surfaces as studied by flow-through ATR-FTIR spectroscopy” in Environ. Chem. 2012, 9, 148-157, by Xiaodong Gao and Jon Chorover.

The pH, temperature and any other characteristics to increase the zeta potential of the resultant particle/contaminant combination thus can be altered in the disperser, which can include the holding tank.

The colloidal suspension with the contaminant/particle combination and any other contaminants or particles from the water source can pass to an inlet manifold 125 and be spread for travel through a diffusiophoretic water filter 130. A filtrate 140 of clean water and a waste stream 150 result, with the waste stream having a large portion, preferably more than 99% and more preferably more than 99.9% of the contaminant/particle combination.

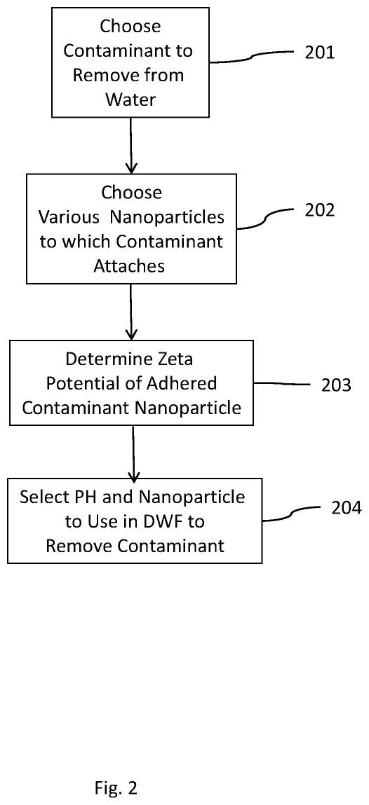

FIG. 2 shows a method for selecting a nanoparticle for use in a diffusiophoretic water filter to remove a particular contaminant. In step 201, a contaminant such as PFOA is selected for removal. Various nanoparticles are used to create nanoparticle/PFOA combinations in step 202. The zeta potential of the adhered combination at the pH and temperature of the water is measured with a commercial zeta potential analyzer, such as available from Brookhaven Instruments Corporation in step 203. In step 204, the zeta potential information is then used to determine the best nanoparticle to use, and if necessary to determine a desired pH and to adjust appropriate characteristics for the diffusiophoretic water filter, such as flow rate, input pressure, CO2 pressure if gas is being used, channel width, length and thickness, and splitter location.

What is claimed is:

1. A method of filtering a colloid in a diffusiophoretic water filter comprising:
adjusting the pH value of the colloid by adding at least one of an acid or a base upstream of the diffusiophoretic water filter; and
filtering the colloid in the diffusiophoretic water filter to produce a waste stream and a filtrate.

2. A method of operating a diffusiophoretic water filter comprising:
adding a nontoxic acid or alkali to a water to be filtered.

3. A method for removing contaminants from water comprising: adding an acid or alkali to the water to alter a zeta potential of at least one contaminant; and imparting diffusiophoretic action on the contaminant to permit the contaminant to be filtered.
